(19) United States
(12) Patent Application Publication
(10) Pub. No.: US 2021/0345635 A1
(43) Pub. Date: Nov. 11, 2021

(54) SYSTEMS AND METHODS FOR SOLUBLE COFFEE TABLETS

(71) Applicant: Shalom NAOR, Rishon Lezion (IL)

(72) Inventor: Shalom NAOR, Rishon Lezion (IL)

(21) Appl. No.: 17/283,428

(22) PCT Filed: Oct. 7, 2019
(86) PCT No.: PCT/IB2019/058511

§ 371 Date: Apr. 7, 2021

Related U.S. Application Data
(60) Provisional application No. 62/742,367, filed on Oct. 7, 2018.

(51) Int. Cl. A23F 5/38; A23F 5/40; A23F 5/42; B65D 85/804

(52) U.S. Cl. CPC A23F 5/385; B65D 85/8043; A23F 5/42; A23F 5/405

(57) ABSTRACT

Systems and methods for soluble coffee tablet comprising a homogeneous compressed mixture of coffee with auxiliary materials adapts to fizz and create foam.

### BACKGROUND

### 1. Technical Field

Embodiments of the present invention relate generally to systems and methods for soluble coffee tablets.

### 2. Description of Related Art

Coffee is a widely consumed product. However, making of fine coffee usually require is a time-consuming process. Instant coffee products are also in high demand however usually lack the finesse of well-prepared coffee.

Hence, an improved systems and methods as described in this application are still a long felt need.

### BRIEF SUMMARY

According to an aspect of the present invention a method for preparing a soluble coffee tablets comprising: mixing fine grounded coffee beans with auxiliary materials adapts to fizz and create foam; compressing said mixture into a homogeneous tablet, wherein said tablet dissolve in liquid while fizzing and creating liquid coffee with foam.

It is further within provision of the invention to be wherein said auxiliary materials comprise milk power.

It is further within provision of the invention to be wherein said auxiliary materials comprise sodium bicarbonate.

It is further within provision of the invention to be wherein said mixture further comprise flavor extracts.

It is further within provision of the invention to be wherein said flavor extract is added after said compression in the form of a bulge on the tablet.

It is further within provision of the invention to be wherein said table is housed by a capsule adapted to be use with a coffee making machine.

Another aspect of the present invention provides a soluble coffee tablet comprising a homogeneous compressed mixture of coffee with auxiliary materials adapts to fizz and create foam.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which.

FIG. 1 illustrates the components of an embodiment of the present invention.

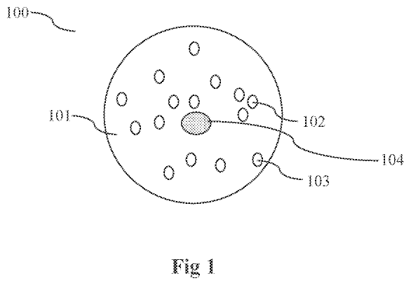

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for soluble coffee tablets.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”. “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g., 1.5, or 10).

The invention relates to systems and methods for allowing preparation of a self-soluble instant coffee from tablets.

Generally speaking, the system and method may allow the production of tablets of highly compressed instant coffee with an addition of an auxiliary materials to also faster dissolving and mixing of the coffee with an addition of foam creation.

The method for preparing a soluble coffee tablets may comprise for following steps.

Mixing fine grounded coffee beans 101 with auxiliary materials that may allow the mixture to fizz 102 and create foam 103 when soaked in water.

Then the mixture may be compressed into a homogeneous tablet.

In some embodiments of the invention, the process may further require further drying of the mixture. Such may be performed prior or post compression, according to the attributes of the specific materials being used.

In an embodiment of the invention, the auxiliary materials may include milk powder, dried milk or other milk substitutes

In an embodiment of the invention, the auxiliary materials may include sodium bicarbonate to allow fizzing that may allow faster and better dissolvement of the grounded coffee in the liquid (usually water, hot or cold).

The result of the use of the product and method may allow an instant liquid coffee with fast and high dissolvement of coffee as well as some degree of foam.

In further embodiments of the invention, flavors may be added to the tablet. Such may be added in the form of a flavor extract bulging from the tablet. Such bulge 104 may further have color coding and hence allowing a user to distinguish one flavor from another prior to using the tablet.

In other embodiments of the invention, the tablet may be adapted to be used in a coffee making machine and hence might be housed in a capsule adapted to be received by a certain coffee making machine.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method for preparing a soluble coffee tablets comprising:
mixing fine grounded coffee beans with auxiliary materials adapts to fizz and create foam;
compressing said mixture into a homogeneous tablet,
wherein said tablet dissolve in liquid while fizzing and creating liquid coffee with foam.

2. The method of claim 1 wherein said auxiliary materials comprise milk power.

3. The method of claim 1 wherein said auxiliary materials comprise sodium bicarbonate.

4. The method of claim 1 wherein said mixture further comprise flavor extracts.

5. The method of claim 4 wherein said flavor extract is added after said compression in the form of a bulge on the tablet.

6. The method of claim 1 wherein said table is housed by a capsule adapted to be use with a coffee making machine.

7. A soluble coffee tablet comprising a homogeneous compressed mixture of coffee with auxiliary materials adapts to fizz and create foam.

8. The method of claim 1 wherein said auxiliary materials comprise milk power.

9. The tablet of claim 7 wherein said auxiliary materials comprise sodium bicarbonate.

10. The tablet of claim 7 wherein said mixture further comprise flavor extracts.

11. The tablet of claim 10 wherein said flavor extract is added after said compression in the form of a bulge on the tablet.

12. The tablet of claim 7 wherein said table is housed by a capsule adapted to be use with a coffee making machine.
